(19) United States
(12) Patent Application Publication
(10) Pub. No.: US 2009/0140699 A1
(43) Pub. Date: Jun. 4, 2009

(54) METHOD AND APPARATUS FOR CHARGING A BATTERY

(75) Inventors: Johannis Friso Rendert Blacquiere, Eindhoven (NL); Jozef Pieter Van Gassel, Eindhoven (NL); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,608

(22) PCT Filed: Dec. 7, 2004
(86) PCT No.: PCT/IB04/52694

§ 371 Date: Jun. 19, 2006

(30) Foreign Application Priority Data
Dec. 22, 2003 (EP) 03104905.9

(51) Int. Cl. H02J 7/04

(52) U.S. Cl. 320/162

(57) ABSTRACT

Portable, battery powered audio playback apparatuses are abundantly available. More and more of these apparatuses have built-in rechargeable batteries. It takes a long time to recharge these batteries. A user may not always need the full amount of power that can be provided by a fully charged battery, but only the amount enough for rendering and reproduction of a limited amount of multimedia data objects. With current art devices, it is difficult to determine when—after which amount of charging time—the battery has enough energy to render a selection of multimedia data objects. Therefore, the invention provides an indicator that indicates during and/or after charging that the battery comprises enough energy to render selected multimedia data objects.

The invention relates to a method of charging a battery for a device comprising a rendering circuit for rendering multimedia data objects

The invention further relates to a circuit for charging a battery for a device comprising a rendering circuit for rendering multimedia data objects.

The invention also relates to an apparatus for rendering multimedia data objects, comprising such circuit.

Such apparatuses are widely known in the art. They are mainly available as Compact Disc® players and MP3 (MPEG 1—layer 3 audio encoding) players. More and more of these apparatuses are provided with built-in rechargeable batteries. They can be charged by means of a voltage transformer with a rectifier connected to the mains power supply of 220 Volts (110 Volts in some areas) or by means of a USB connection of a personal computer.

Recharging of a battery takes a lot of time, usually up to a couple of hours. A user of the apparatus may not always have the time—or patience—to wait until the full battery is recharged. On the other hand, the user may want to be sure that he or she is able to render and reproduce his or her favorite songs without having to recharge the battery in between. There is of course a maximum to the amount of energy a battery can carry, but when the rendering and reproduction of the favorite songs can be done with less than the maximum amount of energy that can be provided by the battery, the battery does not have to be fully recharged to render and reproduce the favorite songs.

To be really sure that there is enough energy in the battery for rendering and reproduction of the favorite songs, the user will always load more energy in the battery than necessary, just to be sure. The loading time used by the user is often a result of trial and error, resulting in annoyance of the user because either not enough energy is provided by the battery or the battery is recharged too long, wasting possibly valuable time of the user.

Therefore, it is an object of the invention to provide feedback to the user on the battery charging process so he or she does not have to load the battery longer than strictly necessary. To achieve this object, the invention provides the method comprising the steps of: providing a list of at least one reference to at least one multimedia data object scheduled for rendering by the rendering circuit; determining the amount of energy needed for rendering the multimedia data object referenced in the list; determining the amount of energy that can be provided by the battery; and when the amount of energy that can be provided by the battery is less than the amount of energy needed for rendering the multimedia data object referenced in the list: charge the battery; and provide an indication when the amount of energy in the battery is equal or more than the amount energy needed for rendering the multimedia data object referenced in the list.

In this way, the user instantly knows when the battery can provide enough energy to render the selected (favorite) multimedia data object or objects in the list and no time is wasted to extra recharging of the battery ‘just to be sure’. Furthermore, when a user does not have time to recharge the battery to the level at which the battery can provide enough energy to render all selected multimedia data objects and removes a power supply for recharging the battery from the apparatus, the user knows on beforehand that not all selected multimedia data objects can be rendered.

In an embodiment of the method according to the invention, the last step comprises the substep of indicating the additional amount of energy with which the battery needs to be charged to be able to power the apparatus to render all multimedia data objects referenced in the list.

An advantage of this embodiment is that the user is provided feedback on approximately how much of the selected multimedia data object or objects can be rendered with the amount of energy at that moment available in the battery.

In another embodiment of the method according to the invention based on the previous embodiment, the additional amount of energy is translated to a time period during which the battery needs to be charged to provide enough energy for rendering all multimedia data objects referenced in the list.

An advantage of this embodiment is that the user knows how much time is left until the battery is charged to the level at which it can provide enough energy to have the selected multimedia objects rendered. The user may seek to use this time usefully and choose an activity to do, consuming the amount of time left for charging.

In yet another an embodiment of the method according to the invention, the process of charging the battery is terminated when the amount of energy in the battery is equal to a pre-determined amount.

In yet a further embodiment of the method according to the invention based on the previous embodiment, the pre-determined amount is equal to the amount of energy needed for rendering the multimedia data object referenced in the list.

An advantage of this embodiment is that no more power is used than strictly necessary, resulting in savings of power consumption.

In again another embodiment of the method according to the invention, the pre-determined amount is equal to the amount of energy needed for rendering the multimedia data object referenced in the list plus a further pre-determined amount proportional to the pre-determined amount.

An advantage of this embodiment is that there will also be enough energy left for rendering of the selected multimedia data objects when the environment has worsened and the battery cannot provide the amount of energy that was determined in first instance.

The circuit according to the invention comprises a circuit for charging a battery for a device comprising a rendering circuit for rendering multimedia data objects, the circuit comprising a central processing unit conceived to: process a list of at least one reference to at least one multimedia data object scheduled for rendering by the rendering circuit and determining the amount of energy needed for rendering items referenced in the list; determining the amount of energy that can be provided by the battery; and when the amount of energy that can be provided by the battery is less than the amount of energy needed for rendering the multimedia data object referenced in the list, charge the battery; and provide an indication by means of the indicator when the amount of energy in the battery is equal or more than the amount energy needed for rendering the multimedia data object referenced in the list.

The apparatus according to the invention comprises such a circuit, an indicator, a rendering circuit and means for providing a multimedia object to the rendering unit.

The invention will now be described in more detailed, with references to various Figures.

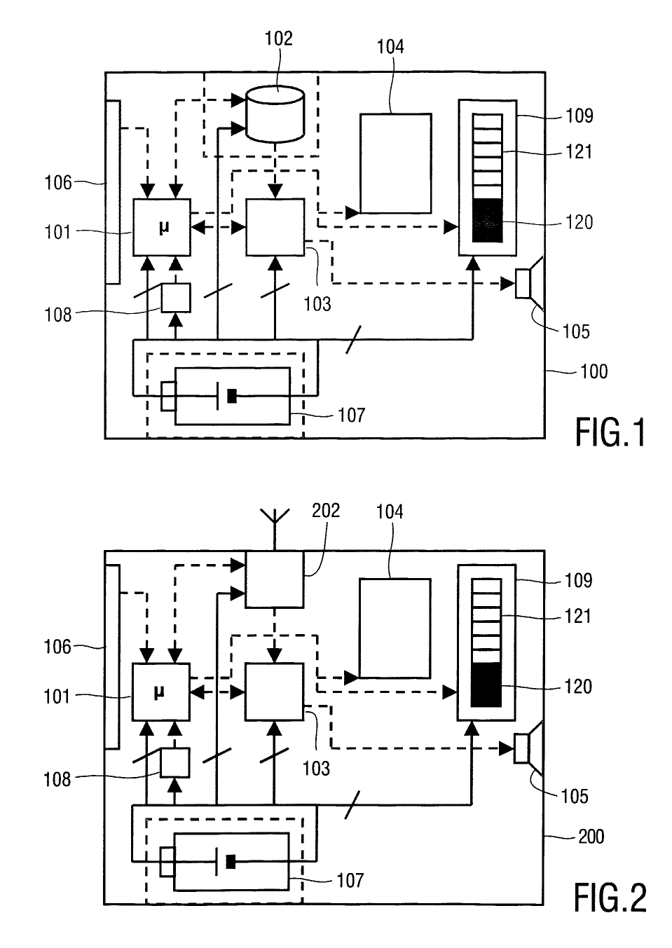

FIG. 1 shows a first embodiment of the apparatus according to the invention; and

FIG. 2 shows a second embodiment of the apparatus according to the invention.

The consumer electronics apparatus 100 as shown in FIG. 1 is an embodiment of the apparatus according to the invention and comprises a microprocessor 101 as a central processing unit for controlling various components of the electronics apparatus 100, a harddisk drive 102 as a memory for storing multimedia data objects, a rendering circuit 103 for rendering multimedia data objects, a display 104 for displaying status information of the apparatus 100 and for displaying rendered multimedia data objects, a speaker 105 for reproducing rendered sound information, a user input unit 106 for enabling a user to control the apparatus 100 and a battery 107 for supplying the various components of the apparatus 100 with energy to ensure proper operation. The apparatus also comprises a battery energy monitor 108 for determining the amount of energy in the battery 107 and an energy indicator 109. The dashed lines around the harddisk drive 102 indicate that it is removable in this embodiment of the invention.

The dashed lines indicate data transport, the solid lines indicate transport of energy. For the sake of simplicity, the solid lines with a diagonal line indicate a positive as well as a negative wire.

A user is enabled to select multimedia objects for rendering (which may comprise reproduce in the context of this application) by controlling the apparatus 100 by means of the user input unit 106. The user input signals are fed to the micro controller 101. In this way, a list 110 is formed with references to multimedia data objects stored in the memory 102, scheduled for rendering by the rendering unit 103 for display on the display 104 and other means like the speaker 105. The list 110 is displayed on the display 104.

As the apparatus 100 is powered by the battery 107, the amount of energy for powering the apparatus 100 is not infinite. It may well be that only a fraction of the content stored on the harddisk 102 can be rendered with the amount of energy stored in the battery 107. Although the user of the apparatus 100 will probably seldom select all stored multimedia data objects for rendering, a harddisk of 40 GB is able to carry over 600 hours of music, of which perhaps at most 10% can be played back with the amount of energy comprised by a conveniently sized battery. 40 GB stores far less hours of video, but a lot more energy is required for properly rendering video.

It is preferred to render selected multimedia data objects in full and have enough energy left in the battery 107 to render selected multimedia data objects in full; either each multimedia data object or all of them (either sequentially—most preferred for music or video—or in parallel—most preferred for still picture data). When the battery 107 has no more energy left while a multimedia data object is not yet fully rendered, a user may miss vital parts of the multimedia data object, which is very annoying. However, also the miss of apparently less vital, subtle parts of the multimedia data object may in some cases by just as annoying, like for example with a classical concert.

Recharging of the battery 107 and usually charging of a battery in general takes a lot of time, up to a few hours. A user may not always have enough time available to recharge the battery 107 in full, but would in any case like to have enough energy to render the selected multimedia data objects.

When a user selects a multimedia data object for rendering, the microprocessor 101 determines the amount of energy needed to render the selected multimedia data object and the battery energy monitor 108 determines the amount of energy left in the battery. Both amounts of energy are compared by the microprocessor 101. When the amount of energy left in the battery 107 is equal or larger than the amount of energy needed for rendering the selected multimedia data object, the data object is rendered.

When the amount of energy left in the battery 107 is not enough for rendering the multimedia data object, the multimedia data object is not rendered. Also, the amount of energy still needed for rendering the multimedia data object is indicated by the energy indicator 109. In another embodiment of the invention, the multimedia data object is rendered when the amount of energy in the battery 107 is insufficient for rendering the selected multimedia data object, but also the amount of energy still needed for rendering the multimedia data object is indicated by the energy indicator 109.

This indication can be provided by a bar 120 like provided with the energy indicator 109 in FIG. 1. During charging of the battery 107, the length of the bar grows. When the length of the bar 120 is equal to the length of a frame 121, the battery is sufficiently loaded to render the multimedia data objects selected for rendering. In an advantageous embodiment of the invention, the amount of energy is translated to an amount of time, during which the battery 107 has to be loaded to provide the battery 107 with enough energy to properly render the selected multimedia data objects. The energy indicator 109 may be comprised by the display 104.

Various other ways of indicating the additional amount of energy needed to render the selected multimedia data objects can be applied in embodiments of the method according to the invention, without departing from the scope of the invention.

In another, less sophisticated but easier to manufacture embodiment of the invention, no indication is provided of an additional amount of energy still needed to render the multimedia data object selected for rendering, but only a light source like an LED (light emitting diode) is switched on or off when during recharging the battery 107 the amount of energy in the battery reaches the amount of energy needed for rendering the selected multimedia data objects. The indicator can also be visualized on the display 104. In an advantageous embodiment of the invention, the process of charging the battery 107 is terminated when the amount of energy in the battery 107 is equal to the amount of energy needed to render the multimedia data objects referenced in the list 110—the selected multimedia data objects.

For determining the amount of energy needed for rendering the selected multimedia data objects, various parameters can be taken into account for determining the amount of energy needed. Examples for parameters are the size of the file, the encoding (or decoding) algorithm, the bitrate at which the data has been encoded or the volume or brightness at which data is being or will be reproduced. But also storage or hardware parameters like the ratio of fragmentation of data on the harddisk 102, the average dissipation of the various components of the apparatus 100 and the ambient temperature can be taken into account.

Methods for determining the amount of energy left in the battery 107 are generally known in the field. Also various parameters can be taken into account, for example the ambient temperature and the (expected) average current drawn from the battery, as these kind of parameters influence the amount of energy a battery can deliver; apart from the amount of energy left in the battery 107.

It may well be that due to change of environmental parameters, for example the ambient temperature, the amount of energy that could be provided by the battery at first, can after all not be provided by the battery. Therefore, according to an embodiment of the invention, the battery energy monitor 108 monitors the amount of energy left in the battery 107 at regular intervals. When during operation of the apparatus 100 it appears that not all multimedia data objects selected at first by the method depicted in FIG. 2, other references to multimedia data objects are unselected or removed from the list 110.

As a matter of safety, an additional amount of energy is loaded in the battery in an advantageous embodiment of the invention, to reduce the impact of worsened environmental parameters. This additional amount may be proportional to the amount of energy needed to render the multimedia data objects referenced in the list 110.

FIG. 2 shows a further apparatus 200 as another embodiment of the apparatus according to the invention. For the sake of clarity, components that appear in the apparatus 100 as well in the further apparatus 200 have been referenced with the same reference number. In the further apparatus 100, the harddisk drive 102 has been replaced by a communication unit 202 for receiving multimedia data objects for rendering. This embodiment of the apparatus according to the invention makes the embodiment of the method according to the invention as described in the previous paragraph even more important. The reason for this is that with current communication units the amount of energy consumed varies with the distance of the further apparatus 200 from a source (like an antenna) of the multimedia data objects.

In the embodiments described, the microprocessor 101 is an embodiment of the circuit according to the invention. The circuit according to the invention, however, may also be embodied in multiple integrated circuits and/or discrete components.

Having described various embodiments of the invention, it will be clear to a person skilled in the art that various embodiments of the invention are possible, without departing from the basics of the invention. Those embodiments can be permutations of the embodiments as described above but also other embodiments.

In summary, the invention relates to the following:

Portable, battery powered audio playback apparatuses are abundantly available. More and more of these apparatuses have built-in rechargeable batteries. It takes a long time to recharge these batteries. A user may not always need the full amount of power that can be provided by a fully charged battery, but only the amount enough for rendering and reproduction of a limited amount of multimedia data objects. With current art devices, it is difficult to determine when—after which amount of charging time—the battery has enough energy to render a selection of multimedia data objects. Therefore, the invention provides an indicator that indicates during and/or after charging that the battery comprises enough energy to render selected multimedia data objects.

1. Method of charging a battery (107) for a device (100, 200) comprising a rendering circuit (103) for rendering multimedia data objects, comprising the steps of:
a) providing a list of at least one reference to at least one multimedia data object scheduled for rendering by the rendering circuit;
b) determining the amount of energy needed for rendering the multimedia data object referenced in the list;
c) determining the amount of energy that can be provided by the battery; and
d) when the amount of energy that can be provided by the battery is less than the amount of energy needed for rendering the multimedia data object referenced in the list:
(i) charge the battery; and
(ii) provide an indication (120) when the amount of energy in the battery is equal or more than the amount energy needed for rendering the multimedia data object referenced in the list.

2. Method according to claim 1, wherein step d) comprises the substep of indicating the additional amount of energy with which the battery needs to be charged to be able to power the apparatus to render all multimedia data objects referenced in the list.

3. Method according to claim 2, wherein the additional amount of energy is translated to a time period during which the battery needs to be charged to provide enough energy for rendering all multimedia data objects referenced in the list.

4. Method according to claim 1, wherein the process of charging the battery is terminated when the amount of energy in the battery is equal to a pre-determined amount.

5. Method according to claim 4, wherein the pre-determined amount is equal to the amount of energy needed for rendering the multimedia data object referenced in the list.

6. Method according to claim 4, wherein the pre-determined amount is equal to the amount of energy needed for rendering the multimedia data object referenced in the list plus a further pre-determined amount proportional to the pre-determined amount.

7. Circuit (101) for charging a battery (107) for a device (100, 200) comprising a rendering circuit (103) for rendering multimedia data objects, the circuit comprising a central processing unit (101) conceived to:
a) process a list of at least one reference to at least one multimedia data object scheduled for rendering by the rendering circuit and determining the amount of energy needed for rendering items referenced in the list;
b) determining the amount of energy that can be provided by the battery; and
c) when the amount of energy that can be provided by the battery is less than the amount of energy needed for rendering the multimedia data object referenced in the list,
(i) charge the battery; and
(ii) provide an indication by means of sending a signal to an indicator (109) when the amount of energy in the battery is equal or more than the amount energy needed for rendering the multimedia data object referenced in the list.

8. Apparatus for rendering multimedia data objects, comprising an indicator (109), a rendering circuit (103), means (102, 202) for providing a multimedia object to the rendering unit and the circuit according to claim 7.
